(19) United States
(12) Patent Application Publication
(10) Pub. No.: US 2006/0018206 A1
(43) Pub. Date: Jan. 26, 2006

(54) Contents delivering method

(76) Inventors: Miho Akitomo, Tokyo (JP); Daisaku Mori, Osaka (JP); Kenjiro Takagi, Kawasaki (JP); Nobuya Okayama, Kawasaki (JP)

Correspondence Address: Mattingly, Stanger & Malur, P.C., Suite 370, 1800 Diagonal Road, Alexandria, VA, 22314, US

(21) Appl. No.: 10/898,256

(22) Filed: Jul. 26, 2004

(51) Int. Cl. G11B 21/08; G11B 5/09

(52) U.S. Cl. 369/30.01; 369/47.1; 369/59.1

(57) ABSTRACT

A digital contents area displayed on a terminal is detected, and an area to be charged is calculated according to the detected area. A criterion for determining that a user reads the digital contents is a time during which the area of the contents is displayed. If the time is equal to or longer than a predetermined time, the displayed contents area is determined to be an area to be charged. There are two methods, a page-change button method and a scroll method, as a method that measures a contents display time for determining whether an area is to be charged.

### BACKGROUND OF THE INVENTION

The present invention relates to a technology for delivering digital contents, including digital books, to an information terminal, and more particularly to a technology for selling, reading, and charging for digital contents. The information terminal, which performs information processing according to a program, includes a computer and a cellular phone.

Prior art methods of delivering digital contents, in particular, prior art methods of charging for reading digital contents, includes the following.

One method of charging for digital contents on a pay-later basis is to charge for digital contents according to the number of time information is output or the usage frequency of contents. This art is disclosed, for example, in JP-A-2002-24579 (first related art).

Another method of charging for digital contents on a pay-later basis is to allow the user to download many digital books at a time for free and, after downloading, to read the sample of the downloaded digital contents for free. This art is disclosed in JP-A-2002-57644 (second related art).

A still another method of charging for digital contents is to charge for reading images. This art is disclosed in JP-A-2002-304534 (third related art). The third related art collects information on the display time and the scaling and charges for the contents according to this information.

A digital contents user, especially, a digital book user, has a desire to pay for a part that is used (read). That is, the user wants not to pay for a part of contents that is delivered but not used. However, any of the related art methods described above does not introduce a method of charging only for a part that is used.

The method in the first related art, which charges for the output contents according to the number of times the contents are used, does not charge for the part that is read. The method in the second related art, which allows the user to download any number of digital books at a time for free, allows the user to read only the sample part for free after downloading. Therefore, this method does not charge only for the part that the user wants to read but provides the digital book delivery service as if the user browses books in a bookstore. In addition, the method in the third related art, which charges for the contents according to the information on one of the display time and the scaling, does not appear to the user that the user is charged only for the part that is read.

### SUMMARY OF THE INVENTION

It is an object of the present invention to provide a contents delivery system, for use in an electronic delivery contents service not implemented by related arts, that can charge for an information part that is read.

To achieve this object, the system of the present invention stores contents in the storage unit of an information processing device, identifies a reading part, which is defined as a part of contents that is read, in response to an input operation performed by the user for this information processing device in order to display the contents, and calculates the charge amount for the identified reading part.

One aspect of the present invention is to sense a part of contents, displayed on the display unit of the information processing device, and treat that sensed part as the reading part. Another aspect of the present invention is to determine the reading part of a displayed part depending upon whether the displayed part satisfies a predetermined condition. The predetermined condition is, for example, whether or not the part is displayed for a time equal to or longer than a predetermined time. In this case, a still another aspect of the present invention is to determine that a displayed area is charged if the input of change processing for the displayed area (operation for the display) of the contents is not entered for at least a predetermined time. A still another aspect of the present invention is that the predetermined time is changed according to whether the operation for the display is a page-change operation or a scroll operation.

A still another aspect of the present invention is to store coordinate information, which indicates contents coordinates, by associating it with the coordinates of the contents (assigned according to a predetermined rule, for example, at a fixed interval) and to sense a reading part using this coordinate information. For example, the coordinates displayed in the four corners of the display unit are calculated based on the coordinate information.

A still another aspect of the present invention is to change the charge amount according to the size of the reading part and/or the display time of the reading part. In addition, the unit price of the chart amount depends on to which area the reading part belongs.

The present invention is provided, for use in the electronic delivery contents service, to charge the user for an information part that the user reads. The system of the present invention detects the area of contents displayed on a terminal and calculates the charge amount of the area according to the detected area. In addition, digital contents composed of a plurality of areas may also be delivered. In this case, it is also possible to associate each area with an item in each book.

It is difficult to determine whether or not the user reads contents simply because the contents are displayed. A criterion for determining that the user reads contents is the time during which the area containing the contents is displayed. If the time is equal to or longer than a predetermined time, the displayed contents area is determined to be an area that is charged. There are two methods, a page-change button method and a scroll method, as a method that measures a contents display time for determining whether an area is to be charged.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing the configuration of one embodiment of the present invention.

FIG. 2 is a flowchart (1) showing the general processing of a contents delivery method.

FIG. 3 is a flowchart showing the general processing of click-based charging.

FIG. 4 is a flowchart showing the general processing of scroll-based charging.

FIG. 5 is a diagram showing the contents of DB tables owned by a contents delivery company.

FIG. 6 is a diagram showing the DB tables of a contents charging system.

FIG. 7 is a diagram showing the display screen of one embodiment of the present invention.

FIG. 8 is a flowchart (2) showing the general processing of the contents delivery method.

### DESCRIPTION OF THE EMBODIMENTS

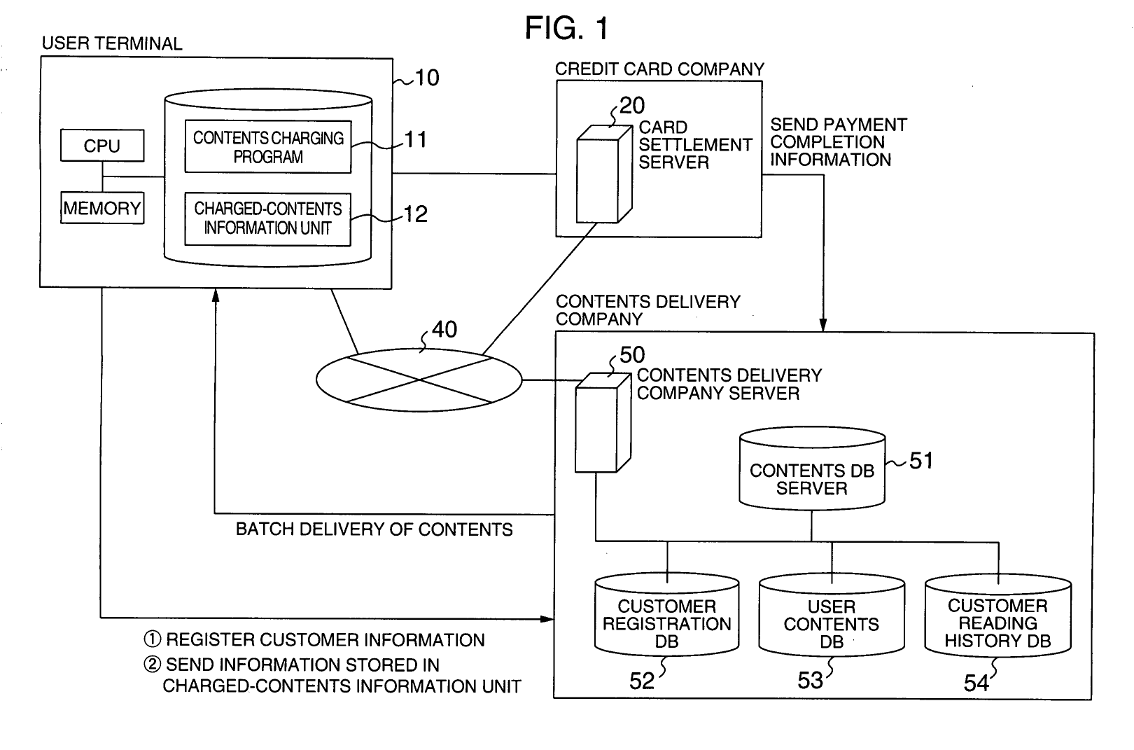

FIG. 1 is a diagram showing the overview of a contents delivery method in an embodiment of the present invention. The user accesses a contents delivery company server 50 from a user terminal 10 via a network 40. The user downloads contents onto the terminal. A contents charging program 11 of the user terminal generates information to be stored in a charged-contents information unit 12. The charged-contents information unit contains contents information for which the user is charged. The charged-contents information unit 12 includes a coordinates storage unit DB 13 and a charged-contents DB 14, which are not shown in FIG. 1. The user terminal 10 sends this information to the contents delivery company server 50, and the user pays the reading fee by a credit card.

The contents delivery company server 50 of a contents delivery company is connected to a contents DB server 51 that manages a customer registration DB 52, a user contents DB 53, and a customer reading history DB 54. A card settlement server 20 of a credit card company, connected to the network 40, sends and receives information to and from the user terminal 10 and the contents delivery company server 50.

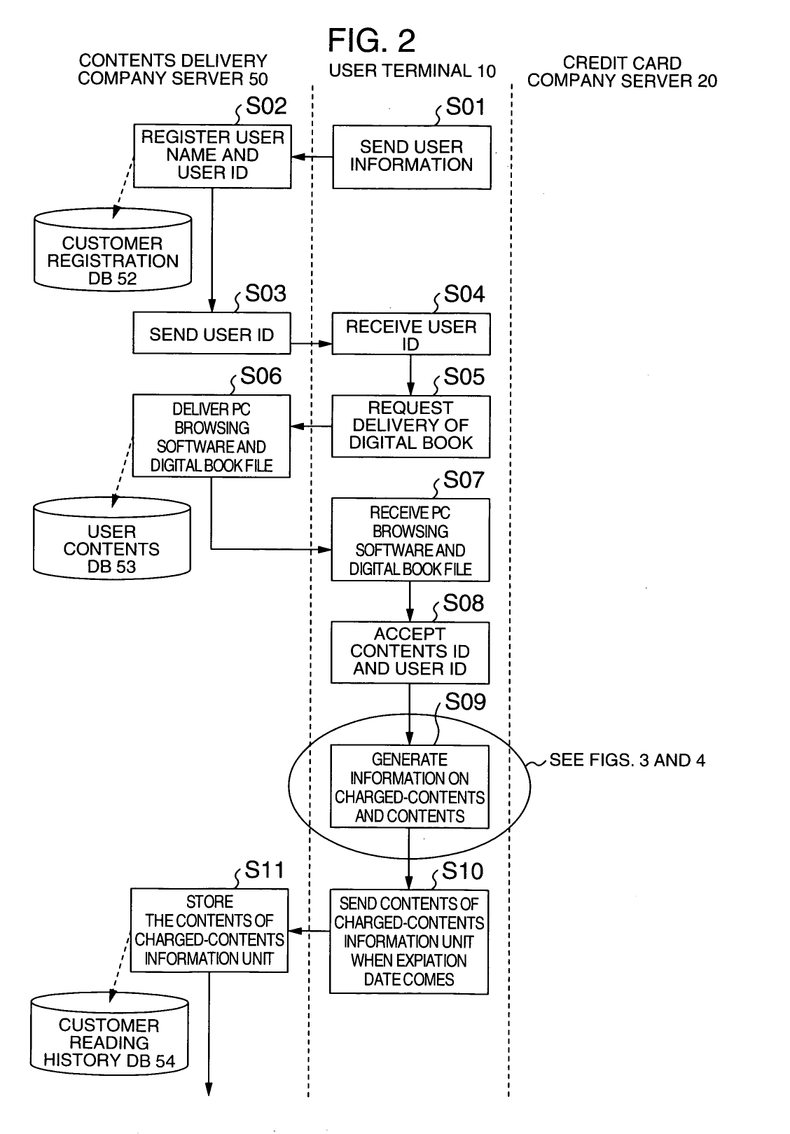

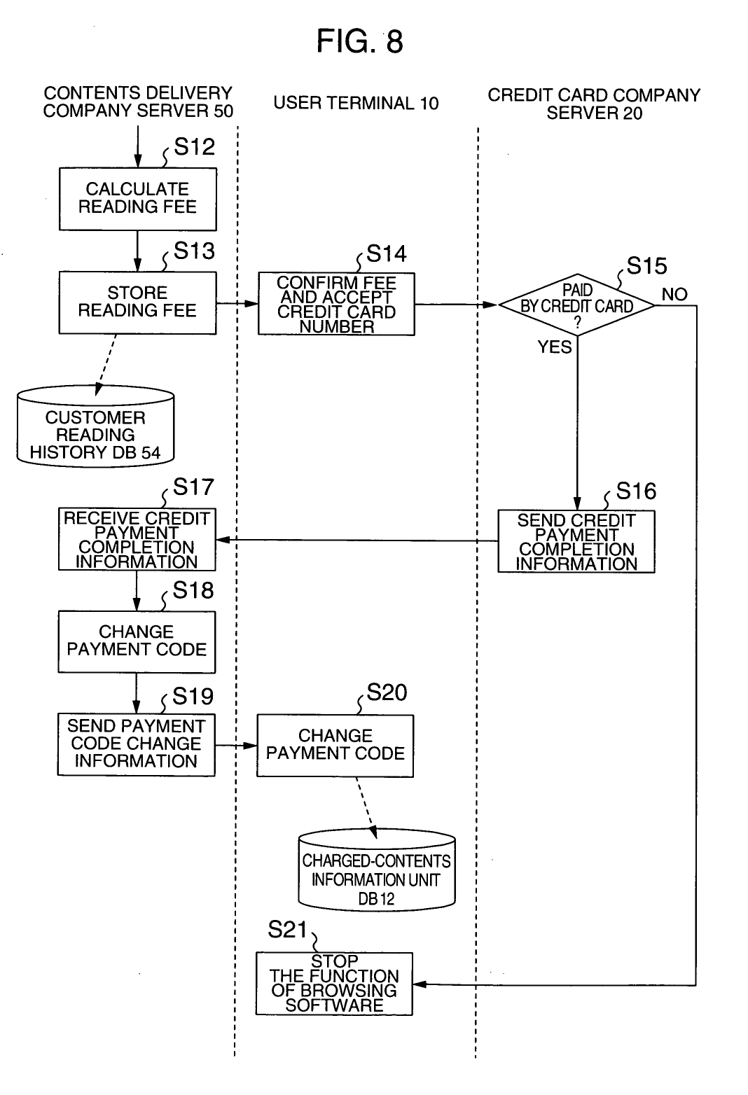

FIG. 2 and FIG. 8 are flowcharts of the embodiment of the present invention. The contents of the processing will be described with reference to the flowcharts. Step S01 to step S11 are shown in FIG. 2, and step S12 and the following steps are shown in FIG. 8.

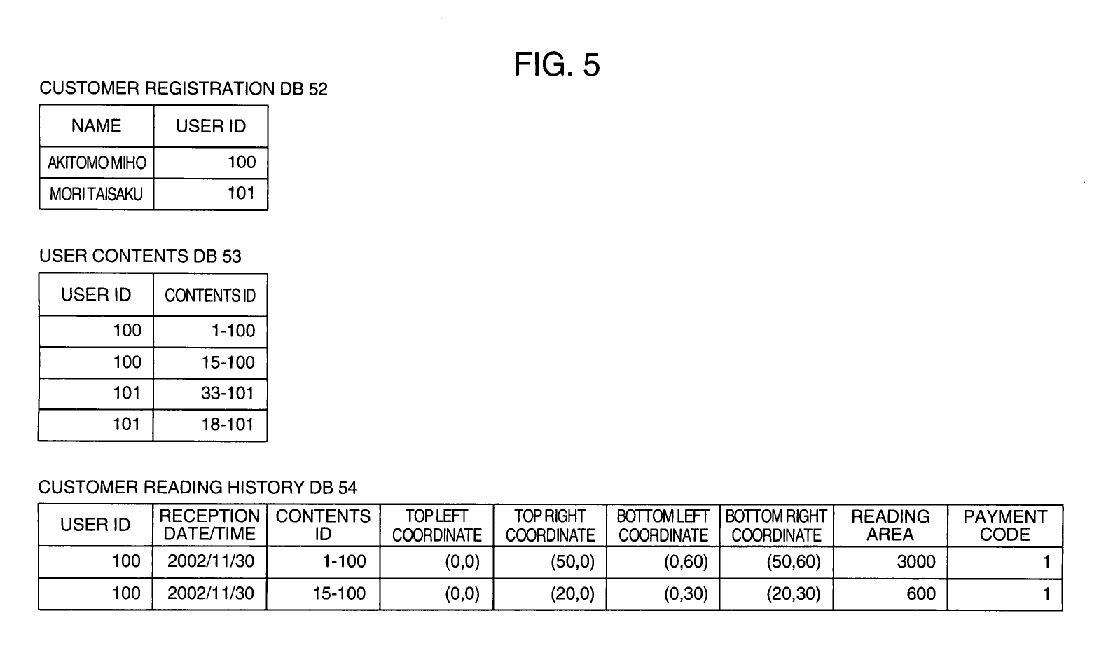

In step S01, the user sends his or her personal information to the contents delivery company. In S02, the contents delivery company registers the personal information, sent in S01, with the customer registration DB 52. FIG. 5 shows the data structure of the customer registration DB 52. In S03, the contents delivery company sends a user ID to the user. In S04, the user receives the ID sent from the contents delivery company. In S05, the user requests the contents delivery company to deliver digital contents. The user can request contents delivery in any units. More specifically, the user can request the delivery of one unit or 100 units of digital contents. In S06, the contents delivery company delivers browsing software and a digital contents file.

The contents delivery company stores the user ID and a contents ID into the user contents DB 53 to keep track of what contents the user will download. FIG. 5 shows the data structure of the user contents DB 53. The contents ID is a number, such as a contents number, to which the user ID is added. This is used to identify the user who reads the contents even if the contents and the browsing software delivered to the user are copied and used by some other user. That is, even if they are copies for reading, the user is obliged to pay the reading fee. In S07, the user receives the browsing software and the digital contents file. In S08, the user enters the contents ID and the user ID into the browsing software to read the downloaded contents. In S09, the content charging program generates information to be stored in the charged-contents information unit. How information stored in this charged-contents information unit is generated will be described later.

In S10, when the expiration date comes, the user sends information, held in the charged-contents information unit of the contents charging system, to the contents delivery company. The expiration date may be set by the contents delivery company, or a service allowing the user to specify the expiration date may be provided. For example, the information stored in the charged-contents information unit is sent to the contents delivery company 31 days after the date on which the contents were received. It is also possible to send it on 30th of every month.

In S11, the contents delivery company stores the information stored in the charged-contents information unit, sent from the user, into the customer reading history DB 54. FIG. 5 shows the data structure of the customer reading history DB 54. Refer to FIG. 8. In S12, the contents delivery company calculates the reading fee based on the customer reading history DB. If the method for identifying the contents using x- and y-axis based coordinates, the contents fee of a particular area of the contents can be set higher than that in other areas. When contents such as magazines including an image, for example, a picture or a drawing that is non-character data, are delivered, it is possible to identify the image area with the coordinates and to collect a higher fee if that area is read.

The present invention can be applied to a sale-by-unit that exploits the characteristics of digital contents rather than those of a paper medium. Both the user and the digital contents delivery company have the advantage in the sale-by-unit of the same contents. In S13, the contents delivery company writes the reading fee, calculated in S12, into the reading fee item in the customer reading history DB. In S14, the user accepts the contents reading fee detailed statement from the contents delivery company and confirms the fee. The reading fee detailed statement may be sent from the contents delivery company to the user via electronic mail or by mail as a paper detailed statement.

The contents fee detailed statement indicates the fee for the read contents held in the charged-contents information unit. In S14, the user enters the card number of a credit card at the contents delivery company site to pay the reading fee by the credit card. It is also possible to pay the reading fee to contents delivery company's account from a bank or a convenience store. Which payment method to use should be decided by the user. When the fee is paid by the credit card in S15, the credit card company sends the information, which indicates that the payment is completed, to the contents delivery company in S16. When the contents delivery company receives the credit card payment information in S17, the contents delivery company changes the payment code in the customer reading history DB 54 to 2.

The contents delivery company changes the payment code in S18 and sends the payment code change information, which is used to change the payment code to payment code 1 that means the payment is completed, to the user in S19.

In S20, when the user receives the payment code change information, the payment code in a charged-contents DB 14 of the charged-contents information unit 12 is changed to 2 that means that the payment is completed. On the other hand, if the credit card payment is not completed in S15, the user cannot receive the payment code change information and, in S21, the function of the browsing software is stopped.

To restart the function of the browsing software, the user is required to send the information, stored in the charged-contents information unit 12, to the contents delivery company. When the contents delivery company receives information from the charged-contents information unit after the function of the browsing software is stopped, it is possible for the contents delivery company to prompt the user to send information from the charged-contents information unit by imposing penalties on the user, for example, by collecting an extra contents reading fee.

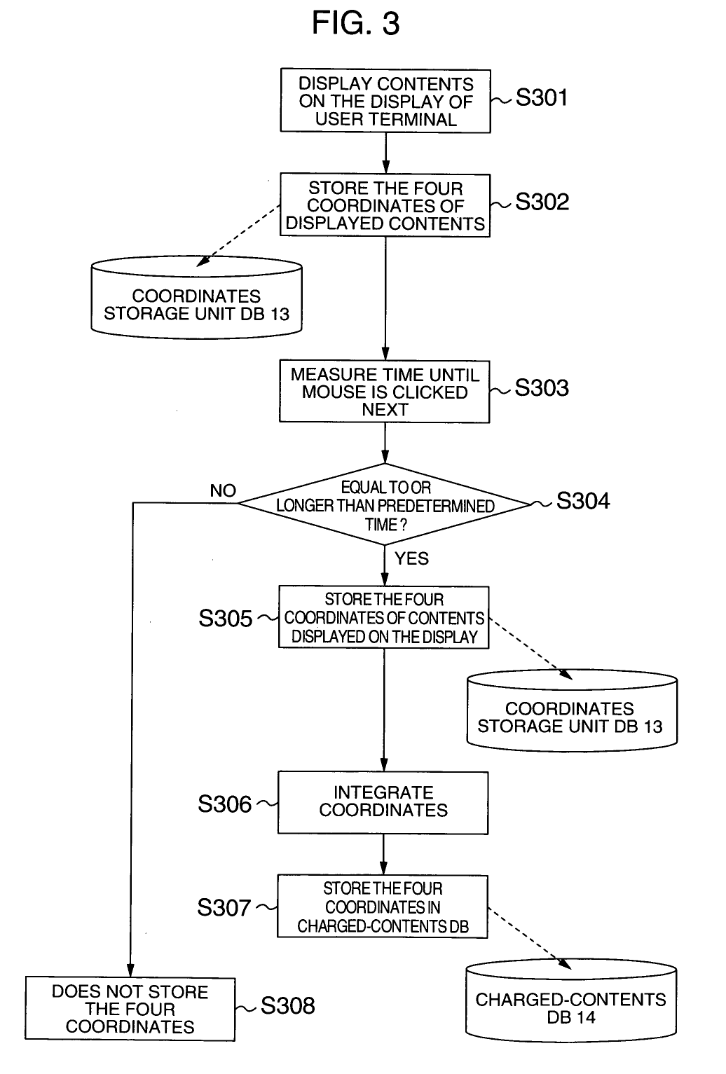

FIG. 3 shows how data stored in the charged-contents DB 14 is generated when the user reads the contents by clicking the page-change button displayed by the contents charging program 11 in this embodiment. The charged-contents DB 14 is in the charged-contents information unit 12.

In S301, the contents are displayed on the display of the user terminal. In S302, the four coordinates of the contents displayed by the browsing software are stored in a coordinates storage unit DB 13 in the charged-contents information unit 12. In S303, the time is measured until the user clicks the mouse to read the next page.

In S304, whether or not the measured time is equal to or longer than a predetermined time is checked. If the measured time is equal to or longer than the predetermined time, control is passed to S305. In S305, the contents after the mouse is clicked are displayed on the display and the four coordinates of the displayed contents are stored in the coordinates storage unit DB 13. In S306, if an area indicated by the coordinates is not separate from another area in the same contents, those areas are integrated and stored in the coordinates storage unit DB 13 as an integrated area. In S307, the coordinate information integrated in S306 is stored in the charged-contents DB 14. If the measured time is shorter than the predetermined time in S304, control is passed to S308.

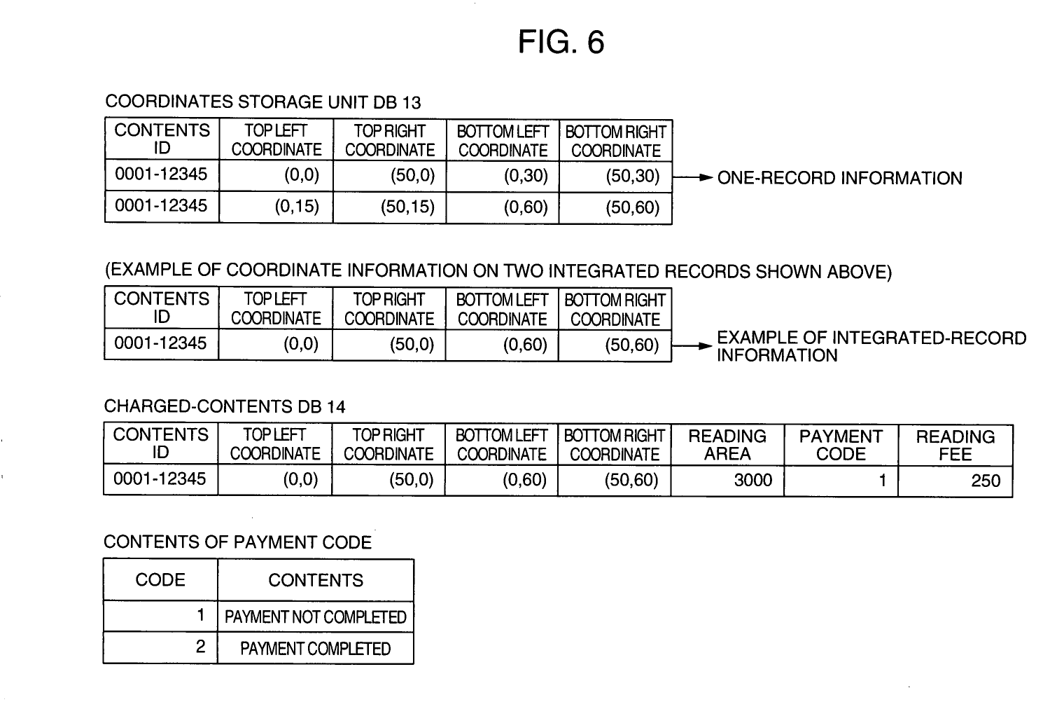

FIG. 6 shows the data structure of the coordinates storage unit DB 13 and the charged-contents DB 14.

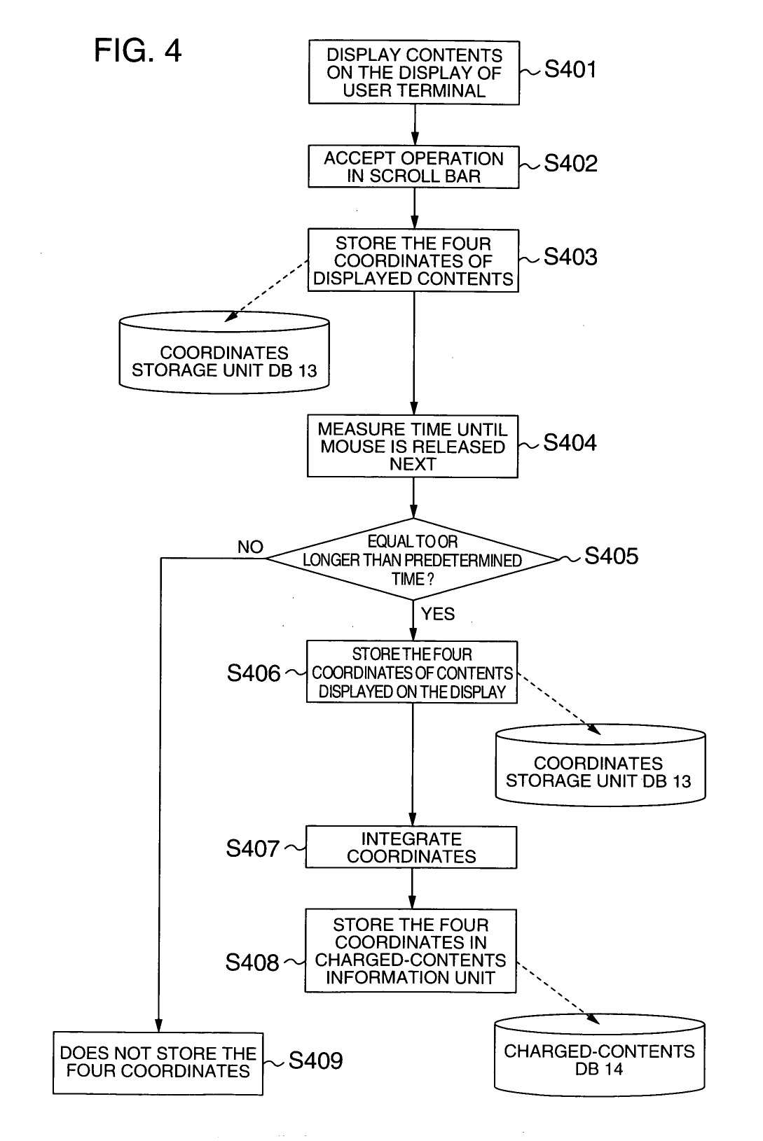

FIG. 4 shows how data stored in the charged-contents DB 14 is generated when the user reads contents using the scroll bar during the execution of the contents charging program 11 in this embodiment.

In S401, contents are displayed on the display of the user terminal. In S402, a user operation is accepted in which the user presses the mouse in the scroll bar or operates other input devices to move the contents. In S403, the four coordinates of the contents displayed by the browsing software are stored in the coordinates storage unit DB 13. In S404, the time is measured until the user releases the mouse to terminate the reading that is operated by the scroll bar. In S405, the measured time is checked if it is equal to or longer than a predetermined time. If the measured time is equal to or longer than the predetermined time, control is passed to S406. In S406, the contents after the mouse is clicked are displayed on the display and the four coordinates of the displayed contents are stored in the coordinates storage unit DB 13. In S407, if an area indicated by the coordinates is not separate from another area in the same contents, those areas are integrated and stored in the coordinates storage unit DB 13 as an integrated area.

In S408, the coordinate information integrated in S407 is stored in the charged-contents DB 14. If the measured time is shorter than the predetermined time in S405, control is passed to S409 and the four coordinates are not stored in the coordinates storage unit DB 13.

To change the movement direction of the scroll box in this embodiment, the user must once release the button. It is also possible for the coordinates storage unit DB 13 to store the screen coordinates that change the movement direction in order to check the reading part. However, if the user moves up and down the scroll box within a short time, the number of operations for keeping track of the coordinates of a correct reading area becomes too large. To reduce the number of operations and to keep the contents charging system of the present invention working smoothly, it is necessary to limit the vertical movement of the scroll box.

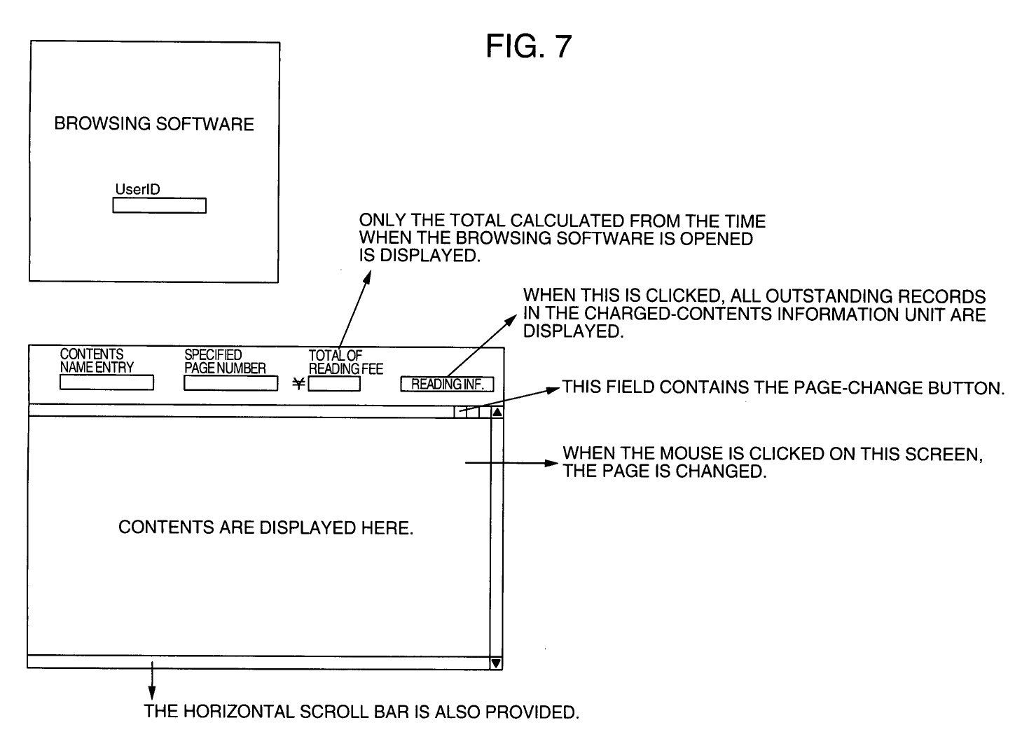

Digital contents, which are displayed by browsing software or some other medium, require that a size of the display screen of the contents be changed. The method according to the present invention, in which the display part is detected as an area, does not require the size of the display screen of the browsing software be fixed. Therefore the user can select a part the user wants to view and the user is charged only for a reading part that satisfies a predetermined criteria. FIG. 7 shows the image of the screen of this browsing software.

The present invention provides a charging method that allows the content provider to use only for digital contents. For example, a large fee can be set for a particular, high-demanding area of one unit (whole) of contents. Therefore, this embodiment is suitable for charging, not for text-only contents, but for magazine contents that includes many images.

The present invention also includes an embodiment in which contents are delivered not via a network. For example, the present invention can be applied to the charging for digital contents installed in a user terminal.

According to the embodiment, the contents provider can charge the user for digital contents more precisely.

It should be further understood by those skilled in the art that although the foregoing description has been made on embodiments of the invention, the invention is not limited thereto and various changes and modifications may be made without departing from the spirit of the invention and the scope of the appended claims.

1. A contents delivery method of delivering digital contents to an information terminal, comprising the steps of:
delivering the digital contents from a contents delivery system, which has digital contents including coordinate data, to the information terminal;
determining if an area, in which the digital contents are displayed by a user operation, is charged when the delivered digital contents are displayed on the information terminal;
identifying the displayed area on the information terminal using the coordinate data if the area is determined to be charged; and
calculating a charge amount of the digital contents according to the identified area.

2. The contents delivery method according to claim 1,
wherein the displayed area is determined to be charged when the displayed area is displayed for a time longer than a predetermined interval of time.

3. The contents delivery method according to claim 2,
wherein the displayed area is determined to be charged when an input of change processing for a display area of the digital contents is not entered for at least a predetermined time.

4. The contents delivery method according to claim 3,
wherein the input of change processing includes a scroll instruction that continuously changes a display screen and a page-change instruction that changes the display screen a predetermined amount at a time.

5. The contents delivery method according to claim 4,
wherein the predetermined interval of time is determined according to the scroll instruction and the page-change instruction.

6. The contents delivery method according to claim 1,
wherein the digital contents has coordinate information indicating coordinates of the digital contents and the displayed area is identified based on the coordinate information.

7. A contents delivery device that delivers digital contents to an information terminal, comprising:
delivering means for delivering the digital contents, which includes coordinate data, to said information terminal;
receiving means for receiving charged-contents information from said information terminal, said charged-contents information identifying an area, which is determined to be charged, using the coordinate data when the digital contents included in the delivered digital contents are displayed on said information terminal and a user performs operation; and
calculation means for calculating a charge amount for the digital contents based on the charged-contents information.

8. The contents delivery device according to claim 7,
wherein, when the displayed area is displayed for a time longer than a predetermined interval of time, said calculation means calculates a charge amount for the displayed area assuming that the displayed area is an area to be charged.

9. The contents delivery device according to claim 8,
wherein said calculation means calculates a charge amount assuming that an area, for which an input of change processing for a display area of the digital contents is not entered for at least a predetermined time, is an area to be charged.

10. The contents delivery device according to claim 9,
wherein the input of change processing includes a scroll instruction that continuously changes a display screen and a page-change instruction that changes the display screen a predetermined amount at a time.

11. The contents delivery device according to claim 10,
wherein the predetermined interval of time is determined according to the scroll instruction and the page-change instruction.

12. The contents delivery device according to claim 7,
wherein the digital contents has coordinate information indicating coordinates of the digital contents and the displayed area is identified based on the coordinate information.
